(19) United States
(12) Patent Application Publication
(10) Pub. No.: US 2006/0196833 A1
(43) Pub. Date: Sep. 7, 2006

(54) Method for isolating hepatocytes

(76) Inventor: David L Morris, New South Wales (AU)

Correspondence Address: FOLEY & LARDNER LLP, P.O. BOX 80278, SAN DIEGO, CA, 92138-0278, US

(21) Appl. No.: 10/517,017

(22) PCT Filed: Sep. 17, 2004
(86) PCT No.: PCT/AU04/01256

§ 371 Date: May 3, 2006

(30) Foreign Application Priority Data
Sep. 19, 2003 (AU) 2003905120

(51) Int. Cl. C02F 1/48

(52) U.S. Cl. 210/695; 435/325; 424/93.7; 424/139.1; 600/300

(57) ABSTRACT

The present invention provides a method for isolating normal hepatocytes, the method comprising the steps of: recovering liver tissue from a patient during a hepatectomy; and isolating normal hepatocytes from unwanted cells present in the recovered tissue by magnetic separation. The invention further provides a method of prepuing hepatocytes for transplantation, the method comprising the steps of: recovering liver tissue from a patient during a hepatectomy; and isolating normal hepatocytes from unwanted cells present in the recovered tissue by magnetic separation.

### TECHNICAL FIELD

The present invention relates generally to methods for isolating hepatocytes suitable for the treatment of patients suffering from liver disorders. The invention further relates to hepatocytes isolated by the methods of the invention and to methods of treating liver disorders using hepatocytes isolated by the methods of the invention.

### BACKGROUND ART

Orthotopic liver transplantation is currently the optimal therapy indicated for a variety of liver disorders including acute and chronic liver failure. However, a limiting factor of liver transplantation is the availability of donor tissue. Worldwide there is a shortage of organs for transplantation. In some instances this has led to mortality rates of approximately 10% on waiting lists for liver transplants (Gibbons, RD et al, Biostatistics 4:207-222, 2003). Other factors limiting the widespread use of liver transplantation include expense of the procedure and the potential for graft is rejection.

Accordingly, there is a need for alternative treatments for patients suffering from liver disorders, not only as an interim measure for those patients awaiting liver transplantation, but also in patients for whom organ transplantation may be inappropriate or as long term alternative to organ transplantation.

One such alternative treatment is hepatocyte transplantatiori which offers several advantages over whole or partial liver transplantation, including reduced cost, less invasive surgery and reduced morbidity (Dhashi, K et al., J Mol Med 79:617-630, 2001). Clinical trials have demonstrated the successful use hepatocyte transplantation, for example in the recovery of patients with acute fulminant hepatic failure (Fisher, RA et al., Transplantation 69:303-307, 2000) and in the treatment of inherited liver disorders such as Criglar-Najjar syndrome (Fox, IJ et al., N Engl J Med 338:1422-1426,1998). However success has been limited.

The most limiting factor in hepatocyte transplantation is the lack of availability of a suitable source of hepatocytes. One source of hepatocytes is livers that are rejected for transplantation. However as a common cause of rejection of livers is steatosis, hepatocytes isolated from these livers often do not have the metabolic capabilities of normal hepatocytes and are thus unsuitable for hepatocyte transplantation. Alternatively, hepatocytes may be sourced from other species. U.S. Pat. No. 6,610,288 discloses the isolation and use of porcine hepatocytes for the treatment of disorders characterised by insufficient liver function. However, a disadvantage of the use of xenogeneic hepatocytes in humans is the potential for rejection.

Accordingly there is a clear need for a suitable source of hepatocytes for transplantation.

### SUMMARY OF THE INVENTION

According to a first embodiment of the present invention there is provided a method for isolating normal hepatocytes, the method comprising the steps of:
(a) recovering liver tissue from a patient during a hepatectomy; and
(b) isolating normal hepatocytes from unwanted cells present in the recovered tissue by magnetic separation.

The hepatectomy may be performed to resect a liver, or a portion thereof, containing a benign or malignant tumour, Accordingly, the unwanted cells may be typically tumour cells.

The method may also comprise the step of removing macroscopic evidence of the tumour-affected tissue from the recovered liver tissue prior to magnetic separation of the cells.

Magnetic separation of cells may be achieved using superparamagnetic colloids coated with an antibody. The antibody may be a monoclonal antibody which specifically recognises an epitope on the surface of the normal hepatocytes or which recognizes the unwanted cells.

According to a second embodiment of the present invention there is provided normal hepatocytes isolated according to the method of the first embodiment.

According to a third embodiment of the present invention there is provided a method of preparing hepatocytes for transplantation, the method comprising the steps of:
(a) recovering liver tissue from a patient during a hepatectomy; and
(b) isolating normal hepatocytes from unwanted cells present in the recovered tissue by magnetic separation.

According to a fourth embodiment of the present invention there is provided normal hepatocytes prepared according to the method of the third embodiment.

Hepatocytes isolated or prepared according the methods of the present invention may be used in hepatocyte transplantation in a patient suffering from a liver disorder. The liver disorder may be selected from the group consisting of: Crigler-Najar Syndrome; Gilbert's Syndrome; Dubin Johnson Syndrome; familial hypercholesterolemia; omithine transcarbamoylase deficiency; hereditary emphysema; haemophilia; viral hepatitis; hepatocellular carcinoma; acute liver failure; and chronic liver failure.

Accordingly, in a fifth embodiment of the present invention there is provided a method for treating a liver disorder in a patient, the method comprising administering to the patient normal hepatocytes isolated according to the method of the first embodiment or prepared according to the method of the third embodiment in an amount and for a time sufficient to treat the liver disorder.

Hepatocytes isolated according the methods of the present invention may also be used in artificial liver support systems.

Typically for the purposes of the above embodiments the patient is human.

According to a sixth embodiment of the present invention there is provided the use of resected liver tissue recovered during a hepatectomy for the isolation of normal hepatocytes, wherein the normal hepatocytes are isolated from unwanted cells in the resected tissue by magnetic separation.

Hepatocytes isolated according the methods of the present invention may be cryopreserved.

### DEFINITIONS

The term “normal hepatocytes” as used herein means hepatocytes that, when isolated, retain the ability to perform the normal cellular functions and activities of hepatocytes in situ and as such are suitable for transplantation into a patient in need of hepatocyte transplantation. Also contemplated within the scope of the term “normal hepatocytes” are hepatocytes. which have been modified, for example modified so as to modulate the expression of a particular gene product, but which nonetheless substantially retain the ability to perform the normal cellular functions and activities of hepatocytes in situ.

The term “isolated” as used herein in the context of hepatocytes means hepatocytes that have been substantially separated from the natural environment and from neighbouring and surrounding cells. The term “isolated” does not refer to hepatocytes present in a tissue section or cultured as part of a tissue section.

The term “liver disorder” as used herein means a disorder or condition characterised by abnormal hepatic function, such as insufficient metabolic activity of the liver, or any disorder associated with hepatic failure, the symptoms of which may be alleviated or reduced by hepatocyte transplantation. Accordingly, the term “treat” as used herein includes alleviating or reducing at least one symptom of a liver disorder.

In the context of this specification, the term “comprising” means “including principally, but not necessarily solely”. Furthermore, variations of the word “comprising”, such as “comprise” and “comprises”, have correspondingly varied meanings.

### BRIEF DESCRIPTION OF THE DRAWINGS

The present invention will now be described, by way of example only, with reference to the following drawings.

FIG. 1. Amplification of the epithelial cell marker Ep-CAM by RT-PCR. Lanes: (1) Molecular weight marker; (2) β-actin control; (3) HT29 cells; (4) pure hepatocytes; (5) hepatocytes plus 50,000 HT29 cells-untreated; (6) hepatocytes plus 50,000 HT29 cells-treated with MOC31 coated Dynabeads; (7) hepatocytes plus 10,000 HT29 cells-untreated; (8) hepatocytes plus 10,000 HT29 cells-treated with MOC31 coated Dynabeads. (In each case 106 hepatocytes were mixed with the indicated numbers of HT29 cells.)

FIG. 2. Amplification of the epithelial cell marker Ep-CAM by RT-PCR. Lanes: (1) Molecular weight marker; (2) β-actin control; (3) HT29 cells; (4) pure hepatocytes; (5) hepatocytes plus 10,000 HT29 cells-untreated; (6) hepatocytes plus 10,000 HT29 cells- treated with MOC31 coated Dynabeads; (7) hepatocytes plus 1,000 HT29 cells-treated with MOC31 coated Dynabeads; (8) hepatocytes plus 1,000 HT29 cells- untreated. (In each case 10⁶ hepatocytes were mixed with the indicated numbers of HT29 cells.)

### BEST MODE OF PERFORMING THE INVENTION

Currently there is a significant mortality of patients awaiting orthotopic liver transplantation. This is primarily due to shortages of cadaveric livers for transplantation. Similarly, the widespread application of hepatocyte transplantations is limited by the availability of livers and other suitable sources of hepatocytes. It has been calculated that approximately 10-20% of the liver cell mass has to be replaced to support liver failure in adults, requiring approximately 10-15 billion cells in humans, or 100-150g of isolated liver cells.

In patients with benign or malignant tumours of the liver, liver resection is commonly indicated. During these resection operations, considerable amounts of normal, unaffected liver tissue are unavoidably removed together with the tumour-affected tissue.

Accordingly, the present invention provides methods for the isolation of hepatocytes and methods for the preparation of hepatocytes for transplantation, wherein the liver tissue from which the hepatocytes are isolated is obtained from resected material during hepatectomy operations. In addition to obtaining liver tissue from resection operations for metastatic disease, liver to be used for the isolation of hepatocytes according to the invention may be obtairied from other sources, for example from organ donors where the liver has been rejected as unsuitable for transplantation.

Hepatocyte Isolation

Following liver resection, normal tissue may be first separated from tumour-affected or other disease-affected tissue macroscopically prior to subsequent separation of normal hepatocytes from unwanted cells.

Isolation of normal hepatocytes from unwanted cells, for example tumour cells, is achieved by magnetic separation. A variety of techniques and devices for magnetic separation of cells are available and known to those of skill in the art, for example as disclosed in U.S. Pat. No. 4,710,472 (Saur et al.), U.S. Pat. No. 5,108,933 (Liberti et al.) and U.S. Pat. No. 5,795,470 (Wang et al.), the disclosures of which are incorporated herein by reference.

Magnetic separation of cells may be achieved by the use of small magnetic particles, preferably colloids in the form of superparamagnetic polymer beads. The magnetic particles may be of sub-micron or micron diameter. Suitable magnetic beads are readily commercially available from a number of sources. Typically the magnetic beads are coated with a ligand which is capable of specifically binding with molecules on the surface of one or more cell types in a heterogeneous mixture. After formation of complexes between the magnetic beads and the target cells (see below), the mixture is exposed to a magnetic field to enable the removal of the complexes from the mixture.

Cells may be isolated via either positive or negative separation. In negative cell separation the cells that are bound to the magnetic beads are unwanted cells, that is those cells which are to be purged from the heterogeneous mixture. In this case, the magnetic beads will be coated with a ligand which specifically recognises the unwanted cells. In embodiments of the present invention in which normal hepatocytes are to be isolated from tumour cells, the magnetic beads may be coated with a monoclonal antibody specific for a receptor found on tumour cells.

In the case of positive cell separation, it is the normal hepatocytes that are specifically bound to the magnetic beads. Either positive or negative cell separation techniques may be used in the methods of the present invention.

It will be readily appreciated by those skilled in the art that superparamagnetic beads do not represent the only suitable means of magnetically separating hepatocytes from unwanted cells. Alternative magnetic particles and devices known to those in the art may also be employed in the methods of the invention.

The magnetic separation technique employed according to an embodiment of the invention may result in a population of normal hepatocytes of at least about 50% purity (that is, the removal of at least 50% of unwanted cells), at least about 75% purity (the removal of at least 75% of unwanted cells), at least about 80% purity, at least about 85% purity or at least about 90% purity. Improved purity may be achieved by employing multiple rounds separation.

The viability of hepatocytes isolated according to the present invention may be determined by a variety of methods known to those skilled in the art. For example, a dye exclusion test may be used, in which is a dilute solution of a dye is mixed with a suspension of isolated hepatocytes. Hepatocytes that exclude dye are considered to be viable while cells that stain are considered non-viable. A suitable dye for use in a dye exclusion test is trypan blue. Additionally, the functional capabilities of isolated hepatocytes may be determined by a number of alternative procedures, including assays for enzymatic activity, for example the reduction of cytochrome P450.

It is envisaged that in embodiments of the invention the isolated hepatocytes may also be screened to ensure the hepatocytes are essentially free from organisms, for example viruses, that may transmit infection to a recipient of the hepatocytes. For example the hepatocytes may be treated with a suitable labelled antibody capable of specifically detecting the presence of viruses in the cells.

Hepatocytes isolated according to methods of the present invention may be cryopreserved, for example in liquid nitrogen. Media and buffers for cryopreservation are known to those of skill in the art, and typically include suitable concentrations of at least one cryoprotectant such as DMSO or FBS. One suitable cryopreservation buffer is RPMI 1640. A number of cryopreservation protocols have been developed to maximise the viability of stored hepatocytes during and after cryopreservation. For example, suitable methods for cryopreservation of hepatocytes are described in U.S. Pat. No. 6,136,525 (Mullon et al.) and Hengstler et al. (Drug Metabolism Reviews 32:81-118, 2000), the disclosures of which are incorporated herein by reference. Cryopreservation of isolated hepatocytes facilitates the development of a reliable, ongoing source of hepatocytes for hepatocyte transplantation as needed. In this regard, following isolation, hepatocytes may be labelled appropriately with information detailing donor details, including blood group, date of birth of donor, date of liver resection, reasons for resection, isolation procedure, number of cells frozen, and percent viability of hepatocytes at the time of cryopreservation.

Treatment of Liver Disorders

Hepatocytes isolated according to methods of the present invention are suitable for numerous. purposes. Typically, hepatocytes isolated according to the present invention may be used in hepatocyte transplantation. The isolated hepatocytes may also be used, for example, in the production of artificial liver support systems and devices to compensate for loss of liver function in a patient.

Transplantation of hepatocytes isolated according to embodiments of the present invention may be used in the treatment of patients with liver disorders. Liver disorders which may be treated by hepatocyte transplantation of normal hepatocytes isolated according to methods of the present invention include any disorder associated with abnormal hepatic function or hepatic failure.

Suitable liver disorders may be hereditary, including for example Crigler-Najar Syndrome, Gilbert's Syndrome, Dubin Johnson Syndrome, familial hypercholesterolemia, omithine transcarbamoylase deficiency, hereditary emphysema and haemophilia. Alternatively the liver disorder may be non-genetic in origin, for example resulting from drug or toxin ingestion, viral infection or metabolic disease. Examples of liver disorders of viral origin include hepatitis A and hepatitis B. Further liver disorders which may be treated according to the present invention include hepatocellular carcinoma, acute liver failure, chronic liver failure and any other disorder associated with abnormal liver function or activity.

The administration of hepatocytes isolated according to the invention for the treatment of liver disorders is for a time and in an amount suitable to reduce or alleviate at least one symptom of the liver disorder. It will be apparent to one of ordinary skill in the art that the optimal course of treatment, such as, the amount of hepatocyte cells administered and the duration of treatment can be ascertained by those skilled in the art using conventional course of treatment determination tests. Further, it will be apparent to one of ordinary skill in the art that the optimal quantity and spacing of individual dosages of hepatocytes will be determined by the nature and extent of the disorder being treated, the form, route and site of administration, and the nature of the particular individual being treated. Also, such optimum conditions can be determined by conventional techniques.

Administration may be by any appropriate route that results in delivery of the hepatocytes to the required site such that at least a portion of the hepatocytes remain viable. Accordingly, administration may be, for example, by intraperitoneal injection, intravenous or intraarterial infusion, or intrasplenic injection. For intravenous infusion hepatocytes may be delivered via the portal vein, or mesenteric vein for example. Typically at least about 5% of the administered hepatocytes remain viable, more typically at least about 10% remain viable, more typically still at least about 20% remain viable and even more typically at least about 40% remain viable.

To facilitate transplantation, hepatocytes isolated according to the present invention may be bound to microcarrier beads such as collagen-coated dextran beads. Hepatocytes isolated according to the invention may also be administered together with one or more pharmaceutically acceptable carriers and/or diluents. The carriers and diluents must be “acceptable” in terms of being compatible with the other ingredients of the composition, and not deleterious to the recipient thereof. Examples of pharmaceutically acceptable carriers and diluents are demineralised or distilled water; saline solution; vegetable based oils such as peanut oil, safflower oil, olive oil, cottonseed oil, maize oil, sesame oils such as peanut oil, safflower oil, olive oil, cottonseed oil, maize oil, sesame oil, arachis oil or coconut oil; silicone oils, including polysiloxanes, such as methyl polysiloxane, phenyl polysiloxane and methylphenyl polysolpoxane; volatile silicones; mineral oils such as liquid paraffin, soft paraffin or squalane; cellulose derivatives such as methyl cellulose, ethyl cellulose, carboxymethylcellulose, sodium carboxymethylcellulose or hydroxypropylmethylcellulose; lower alkanols, for example ethanol or iso-propanol; lower aralkanols; lower polyalkylene glycols or lower alkylene glycols, for example polyethylene glycol, polypropylene glycol, ethylene glycol, propylene glycol, 1,3-butylene glycol or glycerin; fatty acid esters such as isopropyl palmitate, isopropyl myristate or ethyl oleate; polyvinylpyrridone; agar; carrageenan; gum tragacanth or gum acacia, and petroleum jelly.

Hepatocytes may also be administered in combination with one or more other agents. For example it may be desirable to administer hepatocytes in conjunction with agents to enhance engraftment of the hepatocytes, for example hepatocyte growth factor, or other agents for treating liver disorders such as chemotherapeutic agents or antiviral agents, depending on the nature and severity of the liver disorder being treated. It may also be desirable to administer one or more immunosuppressive agents in combination with the hepatocytes to minimise the risk of eliciting an adverse immune reaction. A variety of suitable immunosuppressive agents are known to those skilled in the art.

For such combination therapies, each component of the combination therapy may be administered at the same time, or sequentially in any order, or at different times, so as to provide the desired therapeutic effect. It may be preferred for the components to be administered by the same route of administration, although it is not necessary for this to be so.

It will also be appreciated by those skilled in the art that isolated normal hepatocytes may be modified as necessary prior to their use in hepatocyte transplantation. Depending on the nature of the liver disorder to be treated by hepatocyte transplantation it may be desirable to increase or decrease the expression of particular gene products in the hepatocytes to be administered. Hepatocytes may be modified to alter the expression levels of specific gene products in the cells, for example by introducing into the hepatocytes a suitable agent, such as a transcription factor capable of inducing the expression of a desired gene. Alternatively, or in addition, the hepatocytes may be modified so as to express a gene product which is otherwise not expressed in unmodified hepatocytes. Nucelotide sequences encoding the desired agent or product may be introduced into isolated hepatocytes by a variety of routine recombinant DNA techniques known to those skilled in the art, and may be introduced in a variety of forms, including as naked DNA, in viral vectors (such as adenoviral vectors) or in defective retroviruses.

The present invention will now be further described in greater detail by reference to the following specific examples, which should not be construed as in any way limiting the scope of the invention.

### EXAMPLES

### Example 1

### Harvesting Hepatocytes Following Liver Resection

Five patients who underwent liver resection for liver metastases had their hepatocytes harvested. The study was approved by the Ethics Committee at St George Hospital, New South Wales, Australia (Approval No. 01/123). Details of the location of metastases in these patients and the resections performed are detailed in Table 1.

TABLE 1
Details of liver resections

| Patient | Primary | Date of liver | Segment | Tumour size |
|---|---|---|---|---|
| (sex) | carcinoma¹ | resection | resected | (cm) |
| 1 (F) | CRC² - Mar 01 | April 2003 | 4 | 4 × 3 × 2 |
| 2 (M) | CRC - Nov 00 | May 2002 | 2, 3 & 4 | 4 × 4 × 2 |
| | | | (harvesting 2 + 3) | |
| 3 (F) | CRC - Nov 00 | April 2002 | 2, 3 | 2 × 2 × 1.5 |
| 4 (M) | CRC - Apr 01 | May 2002 | 2, 3 & 7 | 2 × 2.5 × 2 |
| | | | (harvesting 2 + 3) | 4.5 × 2.7 × 2 |
| 5 (M) | Pancreatic | May 2002 | 5, 6 | 2 × 2 × 1 |
| | Cancer. - Apr | | | |
| | 01 | | | |

¹including date of diagnosis
²CRC—colorectal cancer

Following liver resection, the resected liver segment was transferred to a sterile back table in theatre. A second surgical team resected the tumour, which was then sent to anatomical pathology. One or two vessels at the cut edge of the liver to be harvested were then cannulated with a 2mm feeding tube and the liver segment flushed with hepsaline (5000 units heparin in 1L normal saline) to remove clots from inside the vessels. Hepatic digestion was then performed by a modified Seglen's two step technique (Seglen, Methods Cell Biol 13: 29-34, 1976). The first solution used to flush the liver comprises Leffert's buffer with EDTA 5mmol/L. The second solution used for digesting the liver comprises Leffert's buffer with 0.05g type IV collagenase (Sigma) and Ca²⁺ at 0.3% concentration. The liver segment was perfused with each solution for 10 minutes. Due to the different sizes of individual liver segments and the different sizes of the vessels the flow rates were controlled manually.

After the two stage perfusion, the liver segment was then transferred to the laboratory and disrupted by scalpel into 2-3mm fragments in Leffert's medium. The digested parenchyma was then collected and filtered through a 420μm pore steel mesh and washed three times by centrifugation at 50 × g for 5 minutes at 4° C. Hepatocyte yield and viability was assessed using Trypan blue dye (see Table 2). Cryopreservation of hepatocytes was performed in liquid nitrogen after adding 10% DMSO in tissue culture media.

TABLE 2
Number and viability of hepatocytes/gram of liver

| | Liver | | | | Viable |
|---|---|---|---|---|---|
| Patient | weight (g) | No. of cells | Viability | Cells/g | cells/g |
| 1 | 338 | 5 × 10⁶ | 20% | 15 000 | 3 000 |
| 2 | 73 | 40 × 10⁶ | 60% | 550 000 | 330 000 |
| 3 | 298 | 100 × 10⁶ | 60% | 340 000 | 204 000 |
| 4 | 395 | 300 × 10⁶ | 65% | 760 000 | 494 000 |
| 5 | 250 | 300 × 10⁶ | 72% | 1 200 000 | 864 000 |

### Example 2

### Isolation of Tumour-free Hepatocytes

Following harvesting of viable hepatocytes (Example 1) the hepatocytes are isolated from the associated tumour cells. The immunomagnetic method described by Flatmark et al. (Clinical Cancer Research 8:444-449, 2002) was used to isolate the tumour cells employing superparamagnetic 4.5μm beads (Dynabeads M450; Dynal, Oslo, Norway) coated with the MOC31 monoclonal antibody. MOC31 recognises the Ep-CAM antigen, which is present on the surface of most epithelial cells and in particular is highly expressed in colorectal cancers.

Five million hepatocytes were mixed with one million HT29 colorectal cells in lml of phosphate buffered saline (PBS). 200 μl of Dynabeads M450 were suspended in 1 ml of PBS and 20 μl of MOC31 antibody added. The suspension was incubated at 4° C. for 30 minutes, following which the mixture of Dynabeads coated with MOC31 was added to a tube containing the hepatocytes plus HT29 cell mixture making the total volume up to 2mls. After 30 minutes incubation at 4° C. a magnet was applied to the tube to induce attachment of the tumour cells to the Dynabeads thereby allowing the removal of the tumour cells from the cell mixture.

### Example 3

### Confirmation of Isolation of Tumour-free Hepatocytes

Following the removal of tumour cells by MOC31 coated immunomagnetic beads (Example 2), the hepatocyte preparation was analysed for any remaining tumour cells using RT-PCR for the detection of expression of the epithelial cell adhesion molecule (Ep-CAM) gene. Ep-CAM is a useful cell surface marker, being expressed on the surface of most epithelial cells. and tumour cells, including HT29 cells. The sensitivity of RT-PCR in the detection of tumour cells on the basis of Ep-CAM gene expression is approximately 10 tumour cells per 10⁷ non-tumour cells (Sakaguchi, M et al., Brit J Cancer 79:416422, 1999).

The following primers were used for RT-PCR analysis:

| | |
|---|---|
| Sense strand: | 5′-GAACAATGATGGGCTTTATGA-3′ |
| Antisense strand: | 5′-TGAGAATTCAGGTGCTTTTT-3′ |

Successful PCR amplification of EP-CAM using these primers produces a product of 515bp.

Hepatocytes were harvested as described in Example 1. Hepatocytes were then mixed with HT29 tumour cells in the ratio of: (i) 10⁶ hepatocytes+50,000 HT29 cells; (ii) 10⁶ hepatocytes+10,000 HT29 cells; or (iii) 10⁶ hepatocytes+1,000 HT29 cells. One sample of each mixture was subjected to immunomagnetic separation as described in Example 2 before RT-PCR analysis, while a second sample was untreated and used directly in RT-PCR analysis. Total RNA was isolated using a commercial RNA extraction kit (SuperScript III, Invitrogen, Australia). As a control, RNA was also extracted and analysed from 10⁶ HT29 cells.

For RT-PCR, 10 μl RNA was used with the One Step SuperScript III kit (Life Technologies). The PCR cycling was: 30 min at 53° C.; followed by 3 min at 94° C.; followed by 42 cycles of 94° C. for 30 sec, 56° C. for 30 sec and 72° C. for 30 sec; followed by a final step of 10 min at 72° C. Reactions were then kept at 4° C. until analysed by electrophoresis in a 1.5% agarose gel.

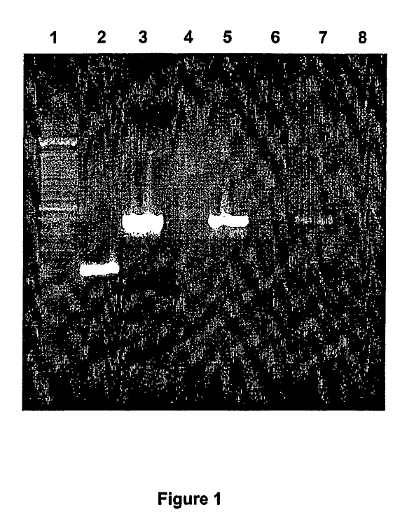

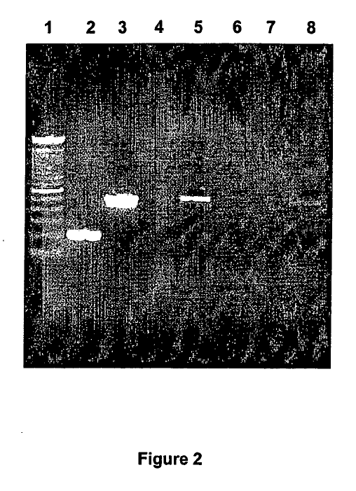

The results are shown in FIGS. 1 and 2. The validity of the Ep-CAM band was confirmed by digestion of the PCR product with BamH1 (data not shown).

By way of control, 25 pg RNA from HT29 cells was sufficient to detect Ep-CAM PCR product (FIG. 1, lane 3; FIG. 2, lane 3) whereas 25 pg RNA of hepatocytes revealed no Ep-CAM PCR product (FIG. 1, lane 4; FIG. 2, lane 4).

The sample containing hepatocytes plus 50,000 HT29 cells not subjected to immunomagnetic separation also revealed Ep-CAM PCR product (FIG. 1, lane 5). In contrast, following treatment of an equivalent sample using MOC31-coated Dynabeads an EP-CAM PCR product was not detected (FIG. 1, lane 6) demonstrating the successful removal of HT29 cells by immunomagnetic separation. Similar results were obtained with samples of hepatocytes plus 10,000 HT29 cells (FIG. 1, lanes 7 and 8; FIG. 2, lanes 5 and 6), and samples of hepatocytes plus 1,000 HT29 cells (FIG. 2, lanes 7 and 8).

1. A method for isolating normal hepatocytes, the method comprising the steps of:
(a) recovering liver tissue from a patient during a hepatectomy; and
(b) isolating normal hepatocytes from unwanted cells present in the recovered tissue by magnetic separation.

2. The method of claim 1 wherein the hepatectomy is performed to resect a liver, or a portion thereof, containing a benign or malignant tumour.

3. The method of claim 2 further comprising the step of removing macroscopic evidence of the tumour-affected tissue from the recovered liver tissue prior to the step of isolating the hepatocytes by magnetic separation.

4. The method of claim 1 wherein the unwanted cells are tumour cells.

5. The method of claim 1 wherein the magnetic separation of cells is achieved using superparamagnetic colloids coated with an antibody.

6. The method of claim 5 wherein the antibody is a monoclonal antibody which specifically recognises an epitope on the surface of the normal hepatocytes.

7. The method of claim 5 wherein the antibody is a monoclonal antibody which specifically recognises the unwanted cells.

8. A method of preparing hepatocytes for transplantation, the method comprising the steps of:
(c) recovering liver tissue from a patient during a hepatectomy; and
(d) isolating normal hepatocytes from unwanted cells present in the recovered tissue by magnetic separation.

9. The method of claim 8 wherein the hepatectomy is performed to resect a liver, or a portion thereof, containing a benign or malignant tumour.

10. The method of claim 9 further comprising the step of removing macroscopic evidence of the tumour-affected tissue from the recovered liver tissue prior to the step of isolating the hepatocytes by magnetic separation.

11. The method of claim 8 wherein the unwanted cells are tumour cells.

12. The method of claim 8 wherein the magnetic separation of cells is achieved using superparamagnetic colloids coated with an antibody.

13. The method of claim 12 wherein the antibody is a monoclonal antibody which specifically recognises an epitope on the surface of the normal hepatocytes.

14. The method of claim 12 wherein the antibody is a monoclonal antibody which specifically recognises the unwanted cells.

15. Normal hepatocytes isolated according to the method of claim 1.

16. Normal hepatocytes prepared according to the method of claim 8.

17-18. (canceled)

19. A method for treating a liver disorder in a patient, the method comprising administering to the patient normal hepatocytes isolated according to the method of claim 1 in an amount and for a time sufficient to treat the liver disorder.

20. The method of claim 19 wherein the liver disorder is selected from the group consisting of: Crigler-Najar Syndrome; Gilbert's Syndrome; Dubin Johnson Syndrome; familial hypercholesterolemia; ornithine transcarbamoylase deficiency; hereditary emphysema; haemophilia; viral hepatitis; hepatocellular carcinoma; acute liver failure; and chronic liver failure.

21. An artificial liver support system comprising normal hepatocytes isolated according to the method of claim 1.

22. A method for isolating normal hepatocytes from resected liver tissue recovered during a hepatectomy, said method comprising isolating normal hepatocytes from unwanted cells in the resected tissue by magnetic separation.

23. A method of preparing normal hepatocytes for transplantation, said method comprising isolating normal hepatocytes, by magnetic separation, from unwanted cells in resected liver tissue recovered during a hepatectomy.

24. A method for treating a liver disorder in a patient, the method comprising administering to the patient normal hepatocytes prepared according to the method of claim 8 in an amount and for a time sufficient to treat the liver disorder.

25. The method of claim 24 wherein the liver disorder is selected from the group consisting of: Crigler-Najar Syndrome; Gilbert's Syndrome; Dubin Johnson Syndrome; familial hypercholesterolemia; omithine transcarbamoylase deficiency; hereditary emphysema; haemophilia; viral hepatitis; hepatocellular carcinoma; acute liver failure; and chronic liver failure.
